(19) United States
(12) Patent Application Publication
(10) Pub. No.: US 2026/0019368 A1
(43) Pub. Date: Jan. 15, 2026

(54) Load Balancing for Multi-Stream Communication Interfaces

(71) Applicant: Altera Corporation, San Jose, CA (US)

(72) Inventors: Wei Chui Ng, Bayan Lepas (MY); Vaibhav Khamkar, San Jose, CA (US)

(21) Appl. No.: 19/337,604

(22) Filed: Sep. 23, 2025

(51) Int. Cl. H04L 47/125; H04L 47/11; H04L 47/129

(52) U.S. Cl. CPC H04L 47/125; H04L 47/11; H04L 47/129

(57) ABSTRACT

Systems, methods, and circuitry for load balancing on communication interfaces are provided. A receiver may include an integrated circuit device which may include a communication interface, such as a Peripheral Component Interconnect Express (PCIe) interface. The integrated circuit device may receive packets and provide the packets to an application program. The integrated circuit device may include multiple buffers for providing the packets to the application program. The integrated circuit device may distribute the packets to the buffers based on functions associated with the packets. In some cases, a buffer may become overloaded based on an increased volume of packets associated with a function. A load balancing stream dispatcher may monitor each of the buffers, identify congestion metrics, and remap the functions to the buffers based on the congestion metrics. In these ways, the load balancing stream dispatcher may provide a technique for efficiently distributing packets on the communication interface.

### BACKGROUND

The present disclosure relates generally to integrated circuits, such as processors and/or field-programmable gate arrays (FPGAs). More particularly, the disclosure relates to systems and methods for load balancing on a communication interface of an integrated circuit, such as a Peripheral Component Interconnect Express (PCIe) interface.

Integrated circuits are found in numerous electronic devices and provide a variety of functionalities. Many integrated circuits, such as field programmable gate arrays (FPGAs), include programmable logic circuitry that may be configured with a hardware system design to implement hardware designs that may perform a wide variety of different functions. In addition to programmable logic circuitry, many integrated circuits also include hardened circuits to perform special-purpose operations, such as buffering and processing data (e.g., packets). Indeed, an integrated circuit may be designed or, in the case of an FPGA, may be configured, to transmit and receive data. That is, an integrated circuit may be included in a receiver and/or a transmitter to facilitate the flow of packets between devices. In the context of a receiver, for example, the integrated circuit may receive packets via a communication link, such as a PCIe link. The integrated circuit may then buffer the packets that it receives from the communication link and provide the packets to an application program. Some receivers may utilize static routing techniques, which may be a source of routing congestion due to communication bandwidth demands associated with one or more functions of the application program.

### BRIEF DESCRIPTION OF THE DRAWINGS

Various aspects of this disclosure may be better understood upon reading the following detailed description and upon reference to examples illustrated in the drawings in which:

FIG. 1 is a block diagram of a system used to program an integrated circuit device;

FIG. 2 is a block diagram of an example integrated circuit device of FIG. 1;

FIG. 3 is a block diagram of a communicative system between a transmitter and a receiver that includes the integrated circuit of FIG. 2;

FIG. 4 is a block diagram of the integrated circuit of the receiver of FIG. 3, including multiple streams and a load balancing stream dispatcher;

FIG. 5 is an example diagram of the load balancing stream dispatcher of FIG. 4 dynamically routing packets to the multiple streams;

FIG. 6 is a flowchart of a method for the load balancing stream dispatcher of FIG. 4 to dynamically map functions to streams; and

FIG. 7 is a block diagram of a data processing system that may incorporate the systems and methods of this disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As mentioned above, a receiver may receive packets from a transmitter via a communication link, such as a Peripheral Component Interconnect Express (PCIe) link. In some cases, the communication link may be a single channel that is used to facilitate the transportation of packets from the transmitter to the receiver. The receiver may be part of an integrated circuit device that may be or may include a communication interface (e.g., a PCIe interface). The communication interface may buffer and provide the received packets to an application program that may be programmed into the receiver (e.g., via programmable logic or circuitry) or running on a processor of the receiver. In some cases, the integrated circuit may include multiple streams (e.g., one or more buffers independently coupled to the application program) for buffering the packets received at the communication link and providing the received packets to the application. For example, the application may be associated with bandwidth or processing constraints that may limit the amount or type of packets that the application can receive at one time. As a result, the integrated circuit may buffer the packets in the multiple streams and provide the packets to the application as the application can receive the packets (e.g., based on communications from the application regarding an availability to receive the packets).

In certain cases, the application program may include multiple functions. The functions may be mapped across the multiple streams such that packets associated with a particular function will be distributed to a stream associated with that function. The load on the functions may change over time (e.g., a function may receive a high number of packets during a first time period and a low number of packets during a second time period). As a result, there may be a disparate distribution of packets between the streams. Thus, it may be desirable for the integrated circuit to include systems and methods for dynamically routing packets

Accordingly, the present disclosure relates to an integrated circuit that is designed for or configurable to support dynamic packet routing on a receiver that is coupled to a transmitter via a communication link. More specifically, the receiver may include a communication interface (e.g., an integrated circuit) that may include a load balancing stream dispatcher. The load balancing stream dispatcher may monitor each of the streams. For example, the load balancing stream dispatcher may determine congestion metrics associated with each of the streams, such as a stream being associated with a higher packet occupancy, an amount of backpressure events, a number of idle cycles (e.g., based on an unavailability of the application program to receive packets from the stream), a number of packets being associated with a particular function and the like. By way of example, if a first stream associated with a first function and a second function is heavily utilized, and a second steam that is associated with a third function is underutilized, the load balancing stream dispatcher may dynamically map the first or second function to the second stream. Put differently, the load balancing stream dispatcher may dynamically map the functions to different streams to cause a more balanced distribution of packets across the streams. In these ways, the load balancing stream dispatcher may use the congestion metrics to dynamically remap the functions across the streams, which may provide an increase in overall system performance as the receiver may buffer and provide packets to the application program in a more efficient manner.

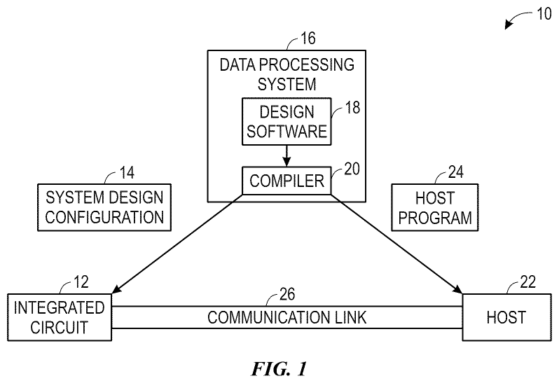

With the foregoing in mind, FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design using a system design configuration 14. Note that, while this disclosure largely refers to the integrated circuit device 12 as being a programmable logic device, such as an FPGA, in some embodiments, the integrated circuit device 12 may also include a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12. As will be discussed in more detail below, the system design configuration 14 may include an application program that may be associated with one or more functions. In particular, the application program may be configured to run the one or more functions on the data processing system 16. For example, the data processing system 16 may execute the application program.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

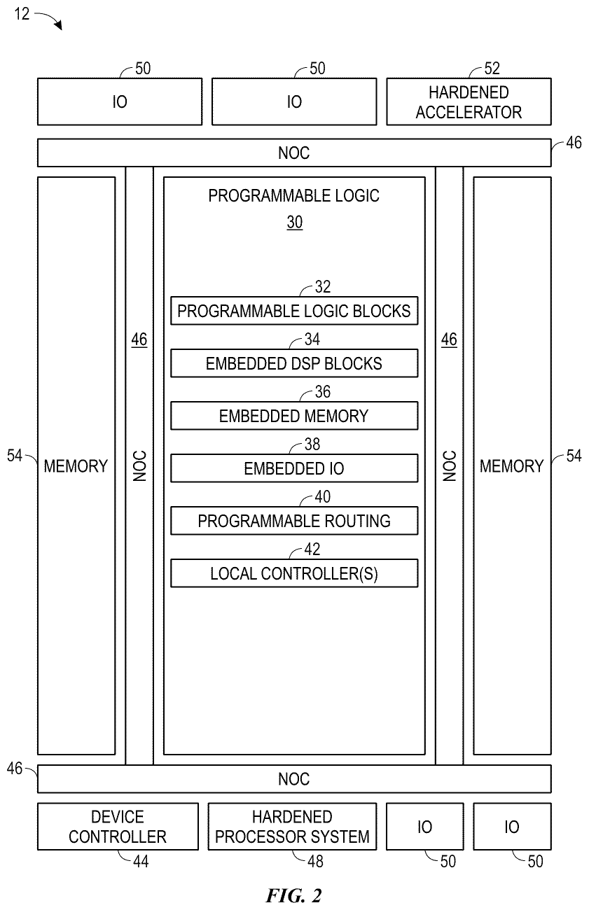

The integrated circuit device 12 may take any suitable form that may implement the system design configuration 14. In one example shown in FIG. 2, the integrated circuit device 12 may include programmable logic circuitry 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally, or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

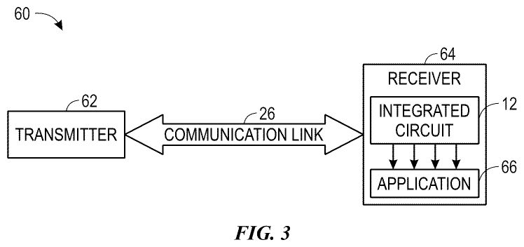

With this in mind, FIG. 3 is a block diagram of a communicative system between a transmitter and a receiver, which may include the integrated circuit device of FIG. 2. For example, a transmitter 62 may be communicatively coupled to a receiver 64 by a communication link 26. The communication link 26 may be a single channel link (e.g., single-channel PCIe link) that facilitates the exchange of data (e.g., packets) between the transmitter 62 and the receiver 64. The receiver 64 may include one or more integrated circuit devices 12 for processing packets that are received by the transmitter 62. For example, the receiver 64 may include an integrated circuit device 12 that may be or include a communication interface, such as a PCIe interface. The integrated circuit device 12 may be communicatively coupled to an application program 66. The application program 66 may be any logic or circuitry (e.g., an application may band) that is communicatively programmed to the receiver 64 (e.g., via the programmable logic blocks 32). Additionally or alternatively, the application program 66 may be any processes running on a processor of the receiver 64 (e.g., being executed by a processor of the data processing system 16). For example, the application program may include direct memory access (DMA) circuitry, storage devices or circuitry, memory, or the like. In some cases, the application program may be configured to run (e.g., implement) multiple functions that may be associated with different purposes or tasks associated with the application program 66. In this way, the integrated circuit device 12 of the receiver 64 may buffer packets that are received by the transmitter 62 and provide the packets to the application program.

In some cases, the communication between the transmitter 62 and the receiver 64 may include different types of packets. For example, in PCIe communications, the transmitter 62 may send different types of packets to the receiver. For example, according to certain communication standards (e.g., PCIe standards), the transmitter may send posted, non-posted, and completion packets to the receiver. Posted packets are packets that the transmitter 62 may transmit to the receiver 64 without specifying that an acknowledgment be returned. Non-posted packets are packets that demand an acknowledgment from the receiver 64. Completion packets are transmitted by the transmitter 62 in response to receiving an acknowledgment by the receiver 64 (e.g., the receiver sends an acknowledgment of a non-posted packet, and the transmitter sends a completion packet in response). The integrated circuit device 12 may receive the different types of packets over the communication link 26 and forward the packets to the application program (e.g., one or more functions of the application program) based on specifications associated with the communication standards (e.g., PCIe ordering rules).

As mentioned above, the integrated circuit device 12 may include multiple streams that are coupled to the application program 66. For example, the integrated circuit device 12 may include the multiple streams to assist in buffering packets in communications corresponding to a particular communication standard. For example, certain communication standards (e.g., PCIe Gen6×16) call for an increasing amount of bandwidth (e.g., 128 gigabytes) at the receiver 64. Some communication interfaces may attempt to satisfy this bandwidth specification by utilizing a single large stream (e.g., 2,048 bits) that is running at a set frequency (e.g., 500 megahertz). However, resource and performance constraints (e.g., area within the integrated circuit, timing specifications for PCIe communications) may make it challenging to incorporate a single stream with these specifications into an integrated circuit. Thus, other communication systems may include multiple smaller streams (e.g., 512 bit streams, 256 bit streams, and so on) for buffering packets. These streams may be independently coupled to the application program 66 to provide the buffered packets to the application program 66. As a result, communications associated with different functions of the application program 66 may be mapped to the streams. For example, packets associated with a first function may be routed to and buffered by a first stream and packets associated with a second function may be routed to a second stream. Thus, each stream may be associated with one or more functions of the application program 66.

In some systems, the transmitter 62 and the receiver 64 may be separate components that are communicatively coupled (e.g., via the communication link 26) in a single device or system. By way of example, the receiver 64 may be a motherboard of a device, and the transmitter 62 may be an expansion card, such as memory, DMA, a solid state drive (SSD), a hard drive, a graphics card, or the like, included in the same device. Likewise, in other cases, the receiver 64 may be an expansion card in a device, and the transmitter 62 may be a motherboard in the same device. The communication link 26 may, therefore, enable bi-directional communication between the transmitter 62 and the receiver 64.

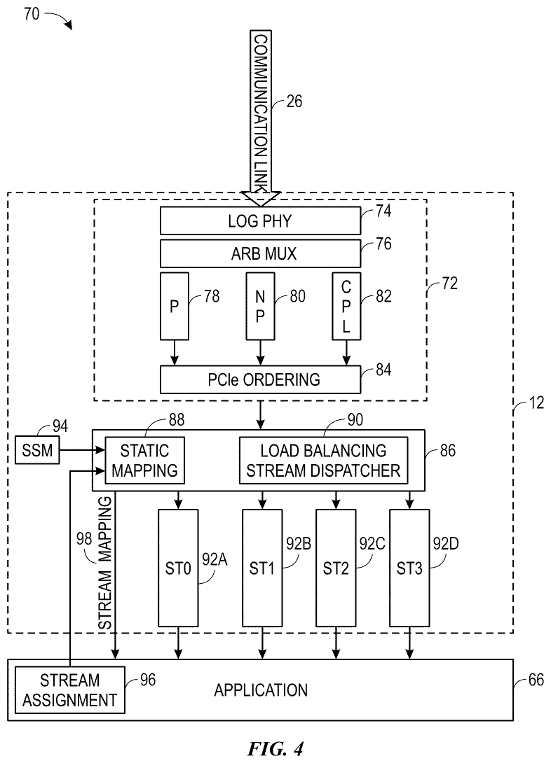

Turning now to a more detailed look at the receiver circuitry, FIG. 4 is a block diagram 70 of the integrated circuit device 12 of the receiver 64 of FIG. 3, including multiple streams and a load balancing stream dispatcher. As mentioned above, the integrated circuit device 12 of the receiver 64 may be viewed as a collection of components that make up a communication interface (e.g., a PCIe interface) for receiving and buffering packets. The integrated circuit device 12 may be coupled to a transmitter (e.g., the transmitter 62 of FIG. 3) via the communication link 26. The communication link 26 may be a single channel link (e.g., a single-channel PCIe link). The communication link 26 may be coupled to a PCIe stack 72. The PCIe stack 72 may include a logical physical layer 74, which may couple to the communication link 26. In this way, the logical physical layer 74 may be an interface to receive high speed data from the communication link 26. The logical physical layer 74 may be coupled to arbitration and multiplexing logic 76. The arbitration and multiplexing logic 76 may receive the data (e.g., packets) from the logical physical layer 74 and separate it into virtual interfaces (e.g., buffers). For example, the arbitration and multiplexing logic 76 may separate the packets into virtual interfaces associated with the type of packets being received. Thus, the PCIe stack 72 may include a first virtual interface 78 for posted packets, a second virtual interface 80 for non-posted packets, and a third virtual interface 82 for completion packets.

The virtual interfaces may be coupled to ordering circuitry 84 (e.g., PCIe ordering circuitry). The ordering circuitry 84 may advance the packets towards the application program 66 according to a communication protocol (e.g., a PCIe protocol). For example, certain communication protocols may define the order in which packets are transmitted from the three virtual interfaces 78, 80, 82 towards the application program 66. As mentioned above, the application program 66 may have a limited amount of bandwidth for the number of packets that it can receive and process. Moreover, the ordering circuitry 84 may apply the communication protocols (e.g., PCIe ordering rules) to determine the ordering of packets to send towards the application program 66. By way of example, if a non-posted packet arrives at the ordering circuitry 84 first, a posted packet arrives second, and a completion packet arrives third (e.g., based on packet timestamps), but the application program 66 only has sufficient bandwidth for the posted packet and the completion packet, then the posted packet and the completion packet will be effectively reordered such that they are sent towards the application program 66 before the non-posted packet.

With this in mind, the ordering circuitry 84 may send packets to a Transaction Layer Packet (TLP) circuit 86. The TLP circuit 86 may include a decoder and router that may extract information from the packets and determine a stream to route the packets towards. As mentioned above, the integrated circuit device 12 may include multiple streams to increase the throughput of the integrated circuit device 12. For example, the integrated circuit may include a first stream 92A (ST0), a second stream 92B (ST1), a third stream 92C (ST2), and a fourth stream 92D (ST3) (collectively referred to as the streams 92). Each of the streams 92 may be independent from one another. For example, each of the streams 92 may be a first in, first out (FIFO) buffer independently coupled to the application program 66.

The TLP circuit 86 may route the packets towards one of these streams 92 based on information extracted from the packets, such as determining which function each packet is associated with. Indeed, packets may be associated with physical functions and/or virtual functions. For example, the TLP circuit 86 may route packets based on physical function numbers, virtual function numbers, or any other suitable routing technique (e.g., the TLP circuit 86 is not limited to routing packets based on physical function numbers or virtual function numbers). For example, the TLP circuit 86 may determine which function a packet is associated with and route the packet to one of the streams 92 based on the function. In some cases, multiple functions may be associated with one stream. For example, two virtual functions, three virtual functions, or any suitable number of virtual functions may be mapped to the stream 92A (ST0).

To determine which streams to route the packets to, the TLP circuit 86 may include a static mapping 88 and a load balancing stream dispatcher 90. The static mapping 88 may include a mapping (e.g., a data structure, a register) that associates various functions with streams 92. In some cases, the static mapping 88 may define an initial allocation of functions to each of the streams 92. By way of example, when compiling the application program 66, the static mapping 88 may receive indications assigning each physical function and virtual function to certain streams 92. As a result, the initial allocation between the streams 92 and the functions may be based on the expected traffic that may be caused by the functions. A system state manager (SSM) 94 may initialize the communication session and program the static mapping 88. The SSM 94 may be implemented in any suitable manner. For example, the SSM 94 may be implemented as programmable logic, hardened circuitry, implemented as software, or the like. As may be appreciated, the SSM 94 may translate one or more inputs to a graphical user interface (GUI) to a bit stream for programming the static mapping 88. As a result, the static mapping 88 may be based on a user allocating (e.g., assigning) the functions to the streams 92 based on the expected traffic for each of the functions. For example, the application program 66 may include a stream assignment 96, which may enable the user to define the static mapping 88 by programming the static mapping 88 at compile time. Additionally or alternatively, in some cases, the application program 66 may adjust the static mapping 88 during runtime (e.g., based on one or more received inputs).

On the other hand, the load balancing stream dispatcher 90 may provide a dynamic mapping of functions to streams 92. For example, as the integrated circuit device 12 receives packets over the communication link 26, the load balancing stream dispatcher 90 may map (e.g., reassign) the functions to the streams 92. The load balancing stream dispatcher 90 may be implemented in a variety of ways. For example, the load balancing stream dispatcher 90 may be implemented as programmable logic (e.g., programmed in the FPGA), implemented using hardened circuitry, or implemented as software. The load balancing stream dispatcher 90 may monitor the streams 92, evaluate the traffic on the streams 92, and route the packets to the streams 92 based on the traffic on the streams 92.

The load balancing stream dispatcher 90 may monitor each stream to determine a number of congestion metrics for a predetermined observation window. The congestion metrics may indicate which streams 92 are overutilized and/or which streams 92 are underutilized. For example, the load balancing stream dispatcher 90 may determine the rate at which packets are distributed to each of the streams 92 and, therefore, the rate at which each of the streams 92 receives packets. Additionally or alternatively, the load balancing stream dispatcher 90 may determine the number of packets corresponding to a particular function that are transmitted to the streams 92. For example, the load balancing stream dispatcher 90 may determine that 100 packets associated with a physical function are sent to the stream 92A (ST0) and 50 packets associated with a virtual function are sent to the stream 92B (ST1). The load balancing stream dispatcher 90 may use this information to determine congestion metrics for each of the streams 92.

The congestion metrics may include a bandwidth and packet occupancy for each stream 92, a number of backpressure events for each stream 92, a number of idle cycles for each stream 92, a number of packets directed to each function, and the like. The load balancing stream dispatcher 90 may determine the bandwidth and packet occupancy for each stream by determining how many packets are in the stream 92 and comparing the number of packets in the stream 92 to the size of each stream (e.g., 512 bits, 256 bits). The number of backpressure events for each stream 92 may refer to packet overflow caused by the inability of the stream 92 to receive packets from the TLP circuit 86. Backpressure events may be indicative of consecutive traffic targeting a particular stream 92. For example, a path (e.g., a single link) between the PCIe stack 72 and the TLP circuit 86 may be a wide link relative to the streams 92 (e.g., 2048 bit communication link compared to 512 bit streams 92), a particular stream 92 (or set of streams 92) could become overloaded (e.g., full) if a high traffic load from the communication link 26 is directed to the particular stream 92. Additionally or alternatively, the application program 66 may contribute to a backpressure event in situations where the application program 66 has insufficient bandwidth to take a particular type of packet from a particular stream 92, which may cause the particular stream 92 to become overloaded. Likewise, the number of idle cycles for each stream 92 may refer to the streams 92 not receiving any packets or receiving less than a threshold number of packets from the TLP circuit 86 during a cycle. In other words, if a particular stream (e.g., the stream 92A (ST0)) does not receive any packets to the stream during a specified period (e.g., a time-period, a period based on a number of packet distributions across all of the streams 92), the particular stream may be experiencing an idle cycle. The number of packets directed to each function may be determined based on information that the load balancing stream dispatcher 90 extracts from each of the packets. For example, the load balancing stream dispatcher 90 may extract content from the packets to determine which function the packets are associated with. The load balancing stream dispatcher 90 may record (e.g., log) the congestion metrics associated with each of the streams 92 during the predetermined time period. The load balancing stream dispatcher 90 system may then act as a decision engine. For example, the load balancing stream dispatcher 90 may analyze the recorded congestion metrics to make routing decisions for each of the functions. In other words, the load balancing stream dispatcher may determine which functions should be mapped to which streams 92 to cause a more efficient (e.g., a more equitable) distribution of packets.

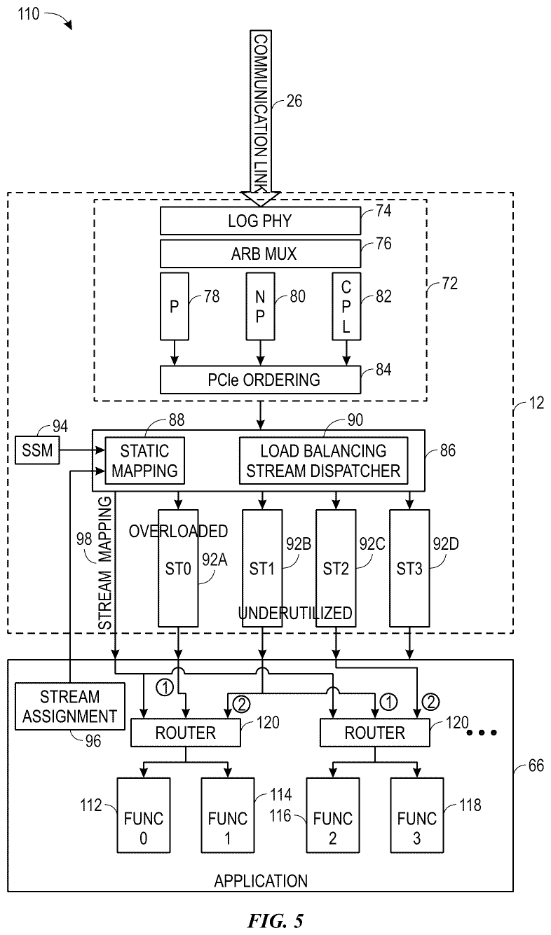

The load balancing stream dispatcher 90 may continuously or periodically remap (e.g., reallocate) the functions to the streams 92 based on the congestion metrics. For example, the load balancing stream dispatcher 90 may record and evaluate the congestion metrics according to a predefined time period (e.g., five seconds, one minute, ten minutes, or so on). In other cases, the load balancing stream dispatcher 90 may dynamically adjust the allocation of the function to the streams. In any event, when the load balancing stream dispatcher 90 identifies that one or more functions should be remapped among the streams 92, it may delay remapping until the streams are empty or drained (e.g., no packets remain on any of the streams 92). The load balancing stream dispatcher 90 may then remaps the functions among the streams 92 and send an indication to the application program 66. For example, the load balancing stream dispatcher may communicate a stream mapping 98 to the application program 66. As will be described in more detail with reference to FIG. 5, the stream mapping 98 may enable the application program 66 to identify and route the packets to its functions.

With this in mind, FIG. 5 is an example diagram 110 of the load balancing stream dispatcher 90 of FIG. 4 dynamically routing packets to the multiple streams. FIG. 5 contains many of the same components that are described with reference to FIG. 4. Thus, for sake of brevity, the following discussion will focus on the differences included in this diagram 110, including an example use case of the load balancing stream dispatcher 90. In this case, the load balancing stream dispatcher 90 is monitoring four streams 92. Initially, the stream assignment 96 of the application program 66 may map packets associated with Function 0 112 and Function 1 114 to the stream 92A (ST0), packets associated with Function 2 116 to the stream 92B (ST1), and packets associated with Function 3 118 to the stream 92C (ST3). For purposes of this example, the stream 92D (ST3) may be associated with other functions. As the integrated circuit device 12 receives more packets, the workload on Function 0 112 and Function 1 114 may increase. Conversely, the workload on Function 2 116 and Function 3 118 may decrease. As a result, the load balancing stream dispatcher 90 may identify congestion metrics indicating that the stream 92A (ST0) may be overloaded while the stream 92B (ST1) and the stream 92C (ST2) may be underutilized. Thus, the load balancing stream dispatcher 90 may remap the functions across the streams 92. For example, the load balancing stream dispatcher 90 may remap Function 1 114 to the stream 92B (ST1) and Function 2 116 to the stream 92C (ST3). Thus, Function 0 112 may remain on the stream 92A (ST0), Function 1 114 may be assigned to the stream 92B (ST1), and Function 2 116 and Function 3 118 may be assigned to the stream 92C (ST2).

After determining that the functions should be remapped, the load balancing stream dispatcher 90 may wait for the streams 92A (ST0), 92B (ST1), and 92C (ST2) to drain. Then, the load balancing stream dispatcher 90 may send the stream mapping 98 to the application program 66. The application program 66 may include one or more routers 120 that may receive (e.g., read from or access) the stream mapping 98 to make forwarding decisions for received packets. In other words, the routers 120 may include logic or circuitry for directing packets received on certain streams 92 to their dedicated functions. For example, the one or more routers 120 may direct the packets received from the stream 92A (ST0) to the Function 0 112. The one or more routers 120 may direct the packets received from the stream 92B (ST1) to the Function 1 114. The one or more routers 120 may direct the stream packets received from the stream 92C (ST2) to the Function 2 116 and Function 3 118. In some systems, the one or more routers 120 may be included or implemented outside of the application program 66. For example, the one or more routers 120 may be included as part of programmable logic or circuitry of the integrated circuit device 12. Additionally or alternatively, the one or more routers 120 may be implemented on a data processing system 16 configured to execute the application program 66.

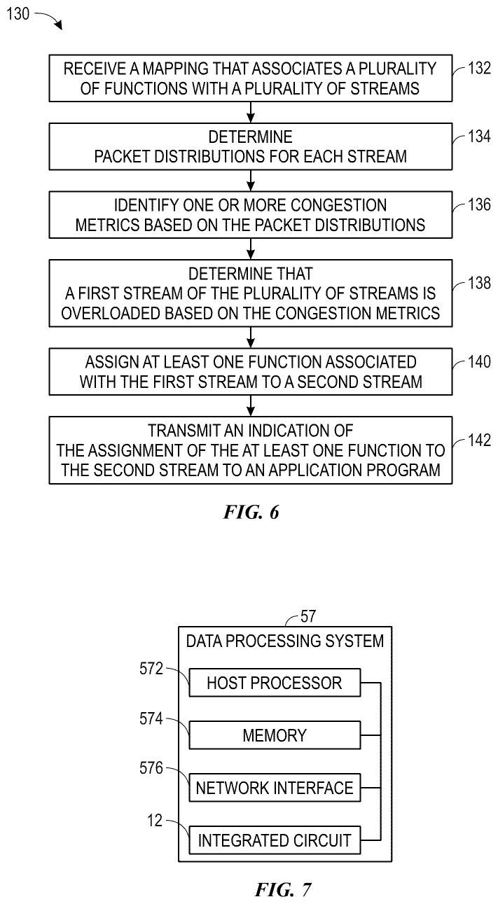

Turning now to a method by which the integrated circuit device 12 of FIG. 4 may operate, FIG. 6 is a flowchart of a method 130 for the load balancing stream dispatcher of FIG. 4 to dynamically map functions to streams 92. Although the following description of the method 130 is described as being performed by the integrated circuit device 12 of FIG. 4, it should be noted that any suitable device capable of receiving and processing data may perform the method 100 described herein. In addition, although the method 130 is described in a particular order, it should be understood that the method 130 may be performed in any suitable order and may exclude one or more of the blocks described herein.

At block 132, the integrated circuit device 12 may receive a mapping associating multiple functions with multiple streams 92. The mapping may include a data structure or one more indications (e.g., signals) that associates each function with a stream 92. In some cases, the integrated circuit device 12 may receive an initial mapping (e.g., a static mapping 88) from an application program 66. For example, the application program 66 may include a stream assignment 96 which may provide the function assignments for the streams 92. In some cases, a device (e.g., a user device) may enter the initial stream assignments while compiling the application program 66 based on expected usage or load on each of the functions. For example, functions that are believed to be associated with a significant load (e.g., a high number of received packets) may be assigned to dedicated streams 92, whereas functions that are believed to be associated with less significant loads (e.g., a low number of received packets) may be combined on certain streams 92.

At block 134, the integrated circuit device 12 may determine packet distributions for each of the streams 92. The integrated circuit device 12 may include a load balancing stream dispatcher 90 that may monitor each of the streams 92. The load balancing stream dispatcher 90 may determine the number of packets distributed to each stream 92, a number of packets received by each stream 92, a number of packets corresponding to a function sent to a stream, and the like. The load balancing stream dispatcher 90 may monitor the streams continuously or for a time period (e.g., a predetermined time period). For example, the load balancing stream dispatcher may record packet distributions for a predetermined observation window. During the predetermined observation window, the load balancing stream dispatcher 90 may log (e.g., record) packet distributions on a data structure or register.

At block 136, the integrated circuit device 12 may identify one or more congestion metrics based on the packet distributions. For example, the load balancing stream dispatcher 90 may use the logged packet distributions for the predetermined time window (block 134) to determine if any of the streams 92 are experiencing congestion or traffic. The congestion metrics may include a bandwidth and packet occupancy for each stream 92, a number of backpressure events for each stream 92, a number of idle cycles for each stream 92, a number of packets directed to each function on each stream 92, and the like.

At block 138, the integrated circuit device 12 may determine that a stream 92 of the multiple streams 92 is overloaded based on the congestion metrics. Further, at block 138, the integrated circuit 12 may determine that another stream 92 of the multiple streams 92 is underutilized based on the congestion metrics. For example, the load balancing stream dispatcher 90 may determine that the stream 92 (or set of streams 92) may be experiencing overload based on the stream 92 being above a threshold number of backpressure events for the predetermined time window. Likewise, the load balancing stream dispatcher 90 may determine that the stream 92 may be experiencing underutilization based on the stream 92 being associated with a number of idle cycles that is above a threshold. In some cases, the load balancing stream dispatcher 90 may determine that the stream 92 is overloaded or underutilized based on the packet occupancy for the stream 92 and the number of packets directed to a particular function being driven to the stream 92. Further still, the load balancing stream dispatcher 90 may use any combination of these metrics or similar metrics to determine that the stream 92 is experiencing overload or underutilization. It should be noted that in some cases, the load balancing stream dispatcher 90 may determine that the streams are not experiencing any overload or underutilization. For example, the load balancing stream dispatcher 90 may have previously remapped the functions to the streams 92. Additionally or alternatively, the static mapping 88 that may be provided by the stream assignment 96 may have successfully distributed the packets between the streams 92. For example, all of the streams 92 may receive a relatively even distribution of packets and, therefore, be associated with congestion metrics that are below defined thresholds. In any event, if the streams 92 are not experiencing overload or underutilization, the load balancing stream dispatcher 90 may continue monitoring each stream 92 (e.g., block 134) to determine if subsequent traffic conditions change cause overload on at least one of the streams 92.

After determining that a stream 92 is experiencing overload, at block 140, the integrated circuit device 12 may assign at least one function associated with the stream (e.g., the stream 92A (ST0)) to another stream (e.g., the stream 92B (ST1)). For example, the load balancing stream dispatcher 90 may use the congestion metrics to determine that a particular function (or set of functions) is a cause of the overload on the stream (e.g., the stream 92A (ST0)). Likewise, the load balancing stream dispatcher 90 may determine that the other stream (e.g., the stream 92B (ST2)) is underutilized based on the congestion metrics. Accordingly, the load balancing stream dispatcher 90 may map (e.g., assign or reassign) at least one of the functions from the stream (e.g., the stream 92A (ST0)) to the other stream (e.g., the stream 92B (ST1)). The load balancing stream dispatcher 90 may remap functions based on their use as indicated by the congestion metrics. Thus, in some cases the load balancing stream dispatcher 90 may reassign the function associated with the most significant load to the other stream (e.g., the stream 92B (ST1)). In other cases, the load balancing stream dispatcher 90 may map the functions to create a more balanced distribution. For example, the load balancing stream dispatcher may reassign a moderately used function to the other stream (e.g., the stream 92B (ST1) to create a balanced distribution of packets among the streams 92.

By way of example, the following specific example is intended to illustrate one use system where remapping functions between the streams 92 may provide a benefit. A data processing application program for market trading may include several virtual functions, which may be associated with different tasks. For example, a first virtual function may be associated with receiving and processing real time market data, a second virtual function may be associated with analyzing historical data to predict future market trends, and additional virtual functions may be associated with related tasks. During trading hours, the first virtual function might process a large volume of real-time market data, whereas the second virtual function may handle less intensive historical data analytics. Thus, the first virtual function may be isolated on a first stream while the second virtual function may be mapped to a second stream that may be shared with several other functions. However, later in the day, trading activity may drop (e.g., as markets close), leading to a reduced load on the first virtual function. Conversely, the second virtual function may experience an increase in volume (e.g., due to a scheduled analysis of the market data for subsequent trading). Because the second virtual function is assigned to a stream that is shared with several other functions, the second stream may become overloaded. However, the first stream associated with the first virtual function may remain underutilized. Thus, the load balancing stream dispatcher 90 may reassign the second function to the first stream. As a result, the data processing application program may be able to process data associated with the second function more efficiently, which may provide a benefit in the time-dependent field of market trading.

Returning back to the method 130, at block 142, the integrated circuit device 12 may transmit an indication of the assignment of the at least one function to the other stream (e.g., the stream 92B (ST1)) to an application program 66. In some cases, after assigning the function from the stream to the other stream (block 140), the load balancing stream dispatcher 90 may wait for the streams 92 that have been remapped/reassigned to drain (e.g., transmit all buffered packets to the application program 66). After the streams 92 are drained, the load balancing stream dispatcher 90 may transmit a stream mapping 98 to the application program 66. Routers 120 on the application program 66 may use the stream mapping to associate the streams 92 with functions (e.g., Function 0 112, Function 1 114, Function 2, 116, Function 3 118). For example, the routers may associate the streams 92 with their assigned functions such that the routers may drive packets that are received on each of the streams 92 to the appropriate function. After transmitting the stream mapping 98 to the application program 66, the load balancing stream dispatcher 90 may continue to route packets towards the streams 92 based on the updated mapping that includes the reassigned functions. The load balancing stream dispatcher 90 may then continue to monitor the streams 92 to determine packet distributions and evaluate stream congestion (blocks 134-138). In these ways, the load balancing stream dispatcher 90 may provide a technique for efficiently distributing loads on multi-stream communication interfaces. As a result, the load balancing stream dispatcher 90 may enable higher bandwidth communications and reduce the risk of communication issues such as buffer overflow and backpressure. Thus, the systems and methods disclosed herein may provide a benefit to communication interfaces, such as PCIe communication interfaces, engaged in highspeed communications.

The integrated circuit device 12 discussed with respect to the receiver 64 above may be a component included in a data processing system, such as a data processing system 500, shown in FIG. 7. The data processing system 500 may include the integrated circuit device 12 (e.g., a programmable logic device, an application program specific integrated circuit (ASIC)), a host processor 502, memory and/or storage circuitry 504, and a network interface 506. The data processing system 500 may include more or fewer components (e.g., electronic display, user interface structures, application program specific integrated circuits (ASICs)). The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit device comprising:
a plurality of buffers coupled to an application program, the plurality of buffers being configured to provide packets to the application program; and
a load balancing stream dispatcher circuit configured to dynamically route the packets to the plurality of buffers based on one or more functions associated with the application program, wherein each function of the one or more functions is associated with a buffer of the plurality of buffers.

EXAMPLE EMBODIMENT 2. The integrated circuit of example embodiment 1, wherein the plurality of buffers are configured to provide the packets to the application program according to a Peripheral Component Interconnect Express (PCIe) protocol.

EXAMPLE EMBODIMENT 3. The integrated circuit of example embodiment 1, wherein the load balancing stream dispatcher circuit is configured to monitor each buffer of the plurality of buffers for congestion metrics.

EXAMPLE EMBODIMENT 4. The integrated circuit of example embodiment 3, wherein the congestion metrics comprises a bandwidth availability for each buffer, a number of backpressure events for each buffer, a number of idle cycles for each buffer, a number of packets directed to each function, or any combination thereof.

EXAMPLE EMBODIMENT 5. The integrated circuit of example embodiment 1, comprising a static mapping, wherein the static mapping is configured to store an initial routing between the one or more functions and the plurality of buffers based on a received input to the application program.

EXAMPLE EMBODIMENT 6. The integrated circuit of example embodiment 1, comprising a Transaction Layer Packet (TLP) circuit, wherein the TLP circuit is configured to transmit an updated mapping to the application program based on the load balancing stream dispatcher circuit reassigning at least one function from a first buffer of the plurality of buffers to a second buffer of the plurality of buffers.

EXAMPLE EMBODIMENT 7. The integrated circuit of example embodiment 1, wherein the load balancing stream dispatcher circuit is configured to delay distributions of the packets to the plurality of buffers after reassigning at least one function from a first buffer to a second buffer, the delay being based on a time to drain the first buffer and the second buffer.

EXAMPLE EMBODIMENT 8. The integrated circuit of example embodiment 1, wherein the load balancing stream dispatcher circuit is implemented as programmable logic or circuitry.

EXAMPLE EMBODIMENT 9. The integrated circuit of example embodiment 1, wherein the plurality of buffers comprises at least two buffers, and each buffer of the plurality of buffers comprises a first in, first out (FIFO) buffer independently coupled to the application program.

EXAMPLE EMBODIMENT 10. A system, comprising:
a communication link configured to receive packets from a transmitter;
a data processing system configured to execute an application program, the application program being configured to perform a plurality of functions; and
a communication interface coupled to the communication link and the data processing system, the communication interface comprising:
   a plurality of buffers coupled to the application program; and
   a load balancing stream dispatcher circuit configured to drive the packets received from the communication link to the application program by mapping each function of the application program to a buffer of the plurality of buffers.

EXAMPLE EMBODIMENT 11. The system of example embodiment 10, wherein the communication link comprises a Peripheral Component Interconnect Express (PCIe) link.

EXAMPLE EMBODIMENT 12. The system of example embodiment 10, wherein the data processing system comprises at least one router, the load balancing stream dispatcher circuit being configured to transmit an indication of a mapping between the plurality of functions and the plurality of buffers to the at least one router.

EXAMPLE EMBODIMENT 13. The system of example embodiment 10, wherein the load balancing stream dispatcher circuit is configured to dynamically reassign one or more functions of the plurality of functions to at least one buffer of the plurality of buffers based on a congestion metric associated with the at least one buffer.

EXAMPLE EMBODIMENT 14. The system of example embodiment 13, wherein the congestion metric comprises a packet occupancy for each buffer, a number of backpressure events for each buffer, a number of idle cycles for each buffer, a number of packets directed to each function, or any combination thereof.

EXAMPLE EMBODIMENT 15. The system of example embodiment 14, wherein the load balancing stream dispatcher circuit is configured to monitor the congestion metrics for a predetermined time period.

EXAMPLE EMBODIMENT 16. The system of example embodiment 13, wherein the plurality of functions comprises at least one Peripheral Component Interconnect Express (PCIe) physical functions and at least one PCIe virtual functions.

EXAMPLE EMBODIMENT 17. The system of example embodiment 10, wherein the load balancing stream dispatcher circuit is configured to map at least two functions of the plurality of functions to one buffer of the plurality of buffers.

EXAMPLE EMBODIMENT 18. A method comprising:
receiving a mapping that associates a plurality of functions with a plurality of streams, each function being associated with a stream;
determining packets distributions for each stream of the plurality of streams;
identifying one or more congestion metrics for each stream of the plurality of streams based on the packet distributions;
determining that a first stream of the plurality of streams is overloaded based on the congestion metrics;
assigning at least one function associated with the first stream to a second stream based on first stream being overloaded; and
transmitting an indication of the assignment of the at least one function to the second stream to an application program.

EXAMPLE EMBODIMENT 19. The method of example embodiment 18, wherein receiving the mapping that associates the plurality of functions with a plurality of streams comprises receiving an input to the application program via a graphical user interface (GUI).

EXAMPLE EMBODIMENT 20. The method of example embodiment 18, comprising determining that the second stream is underutilized based on the congestion metrics, and assigning the at least one function to the second stream based on the second stream being underutilized.

What is claimed is:

1. An integrated circuit device comprising:
a plurality of buffers coupled to an application program, the plurality of buffers being configured to provide packets to the application program; and
a load balancing stream dispatcher circuit configured to dynamically route the packets to the plurality of buffers based on one or more functions associated with the application program, wherein each function of the one or more functions is associated with a buffer of the plurality of buffers.

2. The integrated circuit of claim 1, wherein the plurality of buffers are configured to provide the packets to the application program according to a Peripheral Component Interconnect Express (PCIe) protocol.

3. The integrated circuit of claim 1, wherein the load balancing stream dispatcher circuit is configured to monitor each buffer of the plurality of buffers for congestion metrics.

4. The integrated circuit of claim 3, wherein the congestion metrics comprises a bandwidth availability for each buffer, a number of backpressure events for each buffer, a number of idle cycles for each buffer, a number of packets directed to each function, or any combination thereof.

5. The integrated circuit of claim 1, comprising a static mapping, wherein the static mapping is configured to store an initial routing between the one or more functions and the plurality of buffers based on a received input to the application program.

6. The integrated circuit of claim 1, comprising a Transaction Layer Packet (TLP) circuit, wherein the TLP circuit is configured to transmit an updated mapping to the application program based on the load balancing stream dispatcher circuit reassigning at least one function from a first buffer of the plurality of buffers to a second buffer of the plurality of buffers.

7. The integrated circuit of claim 1, wherein the load balancing stream dispatcher circuit is configured to delay distributions of the packets to the plurality of buffers after reassigning at least one function from a first buffer to a second buffer, the delay being based on a time to drain the first buffer and the second buffer.

8. The integrated circuit of claim 1, wherein the load balancing stream dispatcher circuit is implemented as programmable logic or circuitry.

9. The integrated circuit of claim 1, wherein the plurality of buffers comprises at least two buffers, and each buffer of the plurality of buffers comprises a first in, first out (FIFO) buffer independently coupled to the application program.

10. A system, comprising:
a communication link configured to receive packets from a transmitter;
a data processing system configured to execute an application program, the application program being configured to perform a plurality of functions; and
a communication interface coupled to the communication link and the data processing system, the communication interface comprising:
a plurality of buffers coupled to the application program; and
a load balancing stream dispatcher circuit configured to drive the packets received from the communication link to the application program by mapping each function of the application program to a buffer of the plurality of buffers.

11. The system of claim 10, wherein the communication link comprises a Peripheral Component Interconnect Express (PCIe) link.

12. The system of claim 10, wherein the data processing system comprises at least one router, the load balancing stream dispatcher circuit being configured to transmit an indication of a mapping between the plurality of functions and the plurality of buffers to the at least one router.

13. The system of claim 10, wherein the load balancing stream dispatcher circuit is configured to dynamically reassign one or more functions of the plurality of functions to at least one buffer of the plurality of buffers based on a congestion metric associated with the at least one buffer.

14. The system of claim 13, wherein the congestion metric comprises a packet occupancy for each buffer, a number of backpressure events for each buffer, a number of idle cycles for each buffer, a number of packets directed to each function, or any combination thereof.

15. The system of claim 14, wherein the load balancing stream dispatcher circuit is configured to monitor the congestion metrics for a predetermined time period.

16. The system of claim 10, wherein the plurality of functions comprises at least one Peripheral Component Interconnect Express (PCIe) physical functions and at least one PCIe virtual functions.

17. The system of claim 10, wherein the load balancing stream dispatcher circuit is configured to map at least two functions of the plurality of functions to one buffer of the plurality of buffers.

18. A method comprising:
receiving a mapping that associates a plurality of functions with a plurality of streams, each function being associated with a stream;
determining packet distributions for each stream of the plurality of streams;
identifying one or more congestion metrics for each stream of the plurality of streams based on the packet distributions;
determining that a first stream of the plurality of streams is overloaded based on the congestion metrics;
assigning at least one function associated with the first stream to a second stream based on first stream being overloaded; and
transmitting an indication of the assignment of the at least one function to the second stream to an application program.

19. The method of claim 18, wherein receiving the mapping that associates the plurality of functions with a plurality of streams comprises receiving an input to the application program via a graphical user interface (GUI).

20. The method of claim 18, comprising determining that the second stream is underutilized based on the congestion metrics, and assigning the at least one function to the second stream based on the second stream being underutilized.
